(19) United States
(12) Patent Application Publication
(10) Pub. No.: US 2015/0023543 A1
(43) Pub. Date: Jan. 22, 2015

(54) EARPHONE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YI XIONG, Shenzhen (CN); ZHI-HUA LIN, Shenzhen (CN); HAI-BING JIANG, Shenzhen (CN)

(21) Appl. No.: 14/508,111

(22) Filed: Oct. 7, 2014

Related U.S. Application Data
(62) Division of application No. 13/451,781, filed on Apr. 20, 2012, now Pat. No. 8,887,375.

(30) Foreign Application Priority Data
Aug. 4, 2011 (CN) 201110221959.4

(51) Int. Cl. H04R 1/10

(52) U.S. Cl. CPC H04R 1/1033
USPC 381/380

(57) ABSTRACT

An earphone includes an earphone housing, a soft plastic piece, a speaker positioned in the earphone housing, and an earphone cable connected to the speaker. The earphone housing includes a first housing and a second housing. The soft plastic piece is positioned between the first housing and the second housing, and the soft plastic piece, the first housing and the second housing are fused together.

### CROSS-REFERENCE TO RELATED APPLICATION

The present application is a divisional application of U.S. patent application Ser. No. 13/451,781, filed on Apr. 20, 2012.

### FIELD

The present disclosure generally relates to earphones, and particularly, to an earphone formed by ultrasonic fusion.

### BACKGROUND

An earphone includes an earphone housing, a speaker positioned in the earphone housing, and an earphone cable electrically connected to the speaker. The earphone housing includes a front housing and a back housing glued/engaged to the front housing. However, if the back housing is glued to the front housing, the back housing is easily separated from the front housing due to having low bonding strength between the back housing and the front housing. Meanwhile, if the back housing is engaged to the front housing, the back housing and the front housing require the machining of a special engaging structure, and thus manufacturing costs of the earphone is thereby increased.

### BRIEF DESCRIPTION OF THE DRAWINGS

Implementations of the present technology will now be described, by way of example only, with reference to the attached figures.

FIG. 1 is an isometric, exploded view of a first embodiment of an earphone.

FIG. 2 is similar to FIG. 1, but viewed from another aspect.

FIG. 3 is an isometric view of an ultrasonic fusion device for fusing the earphone of FIG. 1.

FIG. 4 is an isometric view of a cutter cutting the earphone of FIG. 1.

FIG. 5 is an isometric view of a grinding device grinding the earphone of FIG. 1.

FIG. 6 is a flow chart of a method for manufacturing an earphone.

FIG. 7 is an isometric, exploded view of a second embodiment of an earphone.

FIG. 8 is an isometric, exploded view of another embodiment of an earphone.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

The present disclosure is in relation to an earphone which can include an earphone housing, a soft plastic piece, a speaker positioned in the earphone housing, and an earphone cable connected to the speaker. The earphone housing can include a first housing and a second housing. The soft plastic piece can be positioned between the first housing and the second housing. The soft plastic piece, the first housing and the second housing can be fused together.

The present disclosure is further in relation to an earphone which can include an earphone housing, a speaker positioned in the earphone housing, an earphone cable connected to the speaker. The earphone housing can include a first housing and a second housing. The first housing can form a first connecting surface, the second housing forms a second connecting surface. The first connecting surface and the second connecting surface can abut against with each other and are fused together.

The present disclosure is further in relation to an earphone which can include an earphone housing, a soft plastic piece, a speaker positioned in the earphone housing, and an earphone cable connected to the speaker. The earphone housing can include a first housing and a second housing. The first housing can be made of a first plastic material. The second housing can be made of a second plastic material. The soft plastic piece can include a first plastic layer and a second plastic layer. The first plastic layer can be made of the first plastic material and attached to the first housing. The second plastic layer can be made of the second plastic material and attached to the second housing.

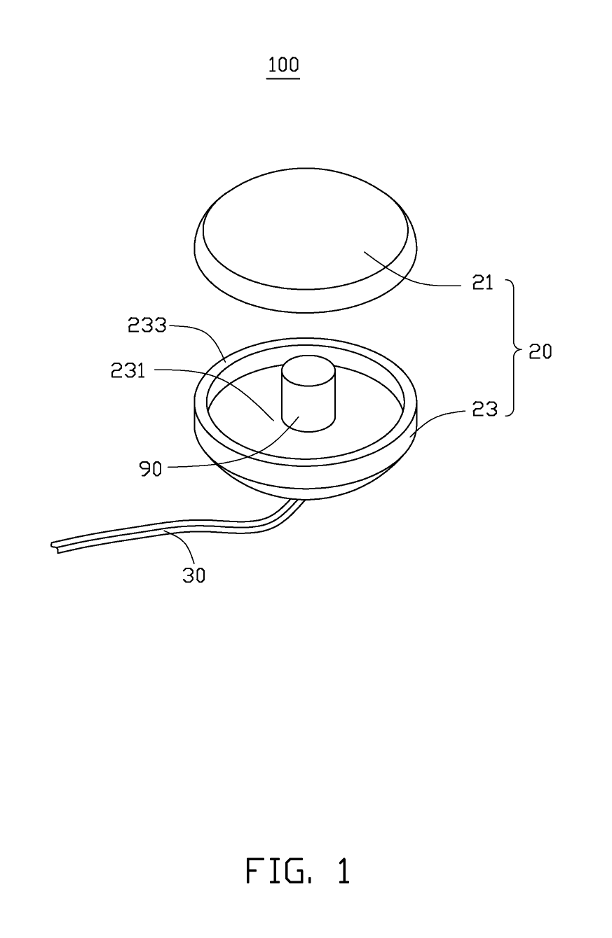

Referring to FIG. 1, a first embodiment of an earphone 100 can include an earphone housing 20, a speaker 90 positioned in the earphone housing 20, and an earphone cable 30 electrically connected to the speaker 90.

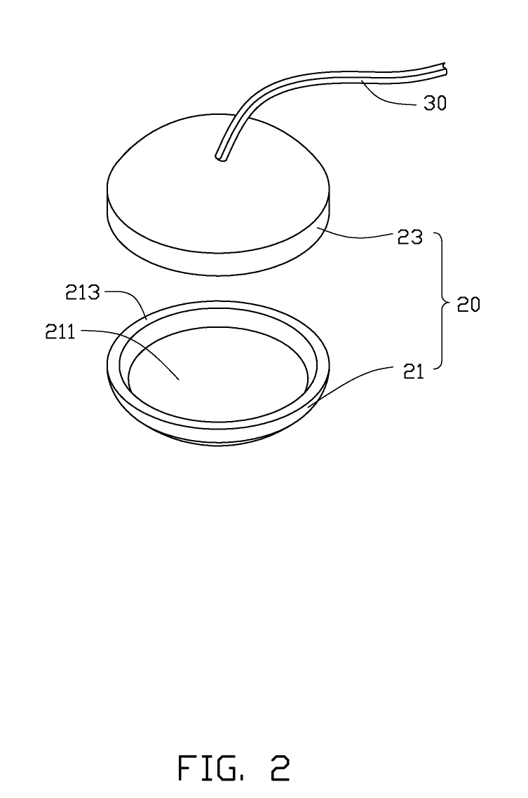

Referring to FIG. 2, the earphone housing 20 can include a first housing 21 and a second housing 23. The first housing 21 can be hemi-spherical and can define a first receiving groove 211. The first housing 21 can form a first connecting surface 213. The second housing 23 can be hemi-spherical and can define a second receiving groove 231 (FIG. 1). The second housing 23 can form a second connecting surface 233 (FIG. 2). In the illustrated embodiment, the first housing 21 and the second housing 23 can be made of a plastic material.

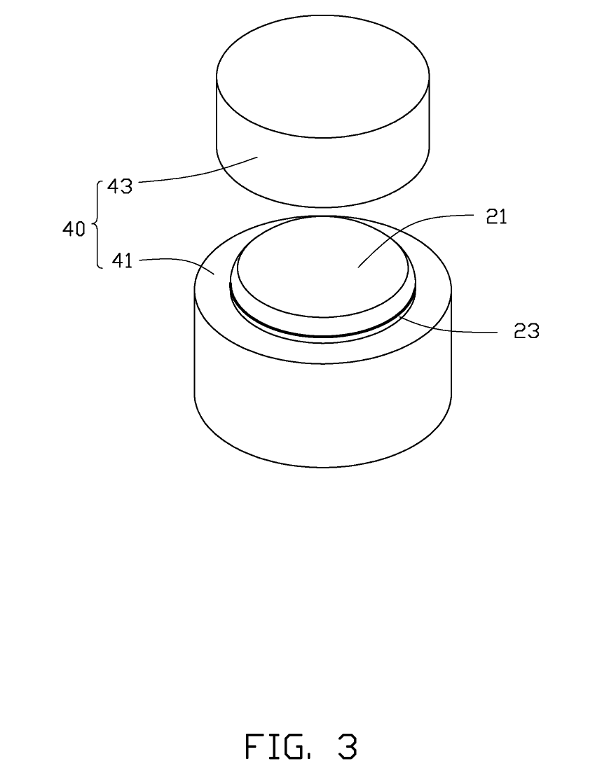

Referring to FIG. 3, the first housing 21 can be positioned on the second housing 23, with the second connecting surface 233 abutting the first connecting surface 213. The first housing 21 and the second housing 23 can be fused together by an ultrasonic fusion device 40.

The ultrasonic fusion device 40 can include a positioning frame 41 and a fusing head 43. The positioning frame 41 can define a positioning groove (not labeled) in a top surface thereof. The second housing 23 can be disposed in the positioning groove of the positioning frame 41, and the second connecting surface 233 can be above the positioning frame 41. The fusing head 43 may also define an assembly groove (not labeled) for partially receiving the first housing 21.

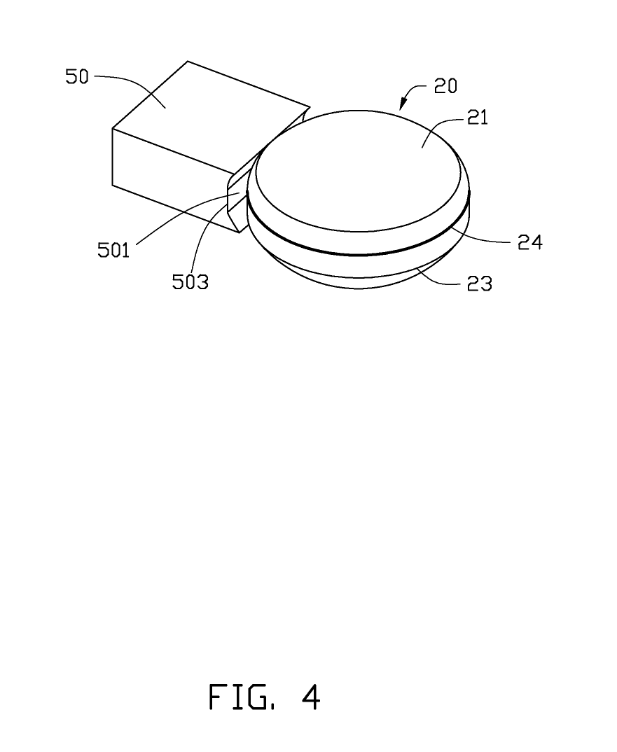

Referring to FIG. 4, after the first housing 21 and the second housing 23 are fused together to form the earphone housing 20, a fusing line 24 can be formed between the first housing 21 and the second housing 23, and an amount of excess plastic can be formed and arranged along the fusing line 24. A cutter 50 can include a profiling surface 501 and a cutting edge 503 formed at a side of the profiling surface 501. The profiling surface 501 can be matched with the outer surface of the earphone housing 20, and the cutting edge 503 can cut off the excess plastic along the fusing line 24.

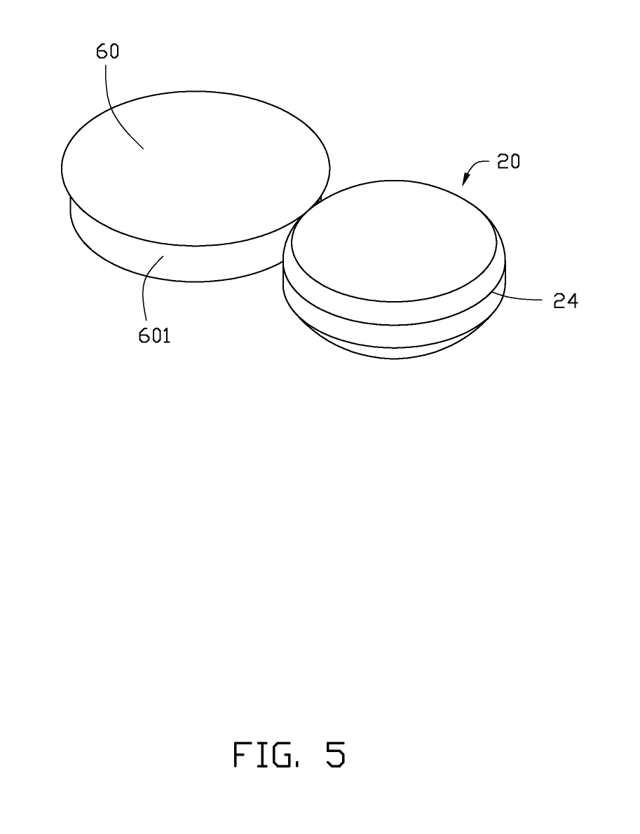

Referring to FIG. 5, after the excess plastic has been removed by the cutter 50, the earphone housing 20 can be ground by a grinding device 60. The grinding device 60 can form a grinding surface 601 matching the side surface of the earphone housing 20 along the fusing line 24. In the illustrated embodiment, the grinding device 60 can be a polishing wheel.

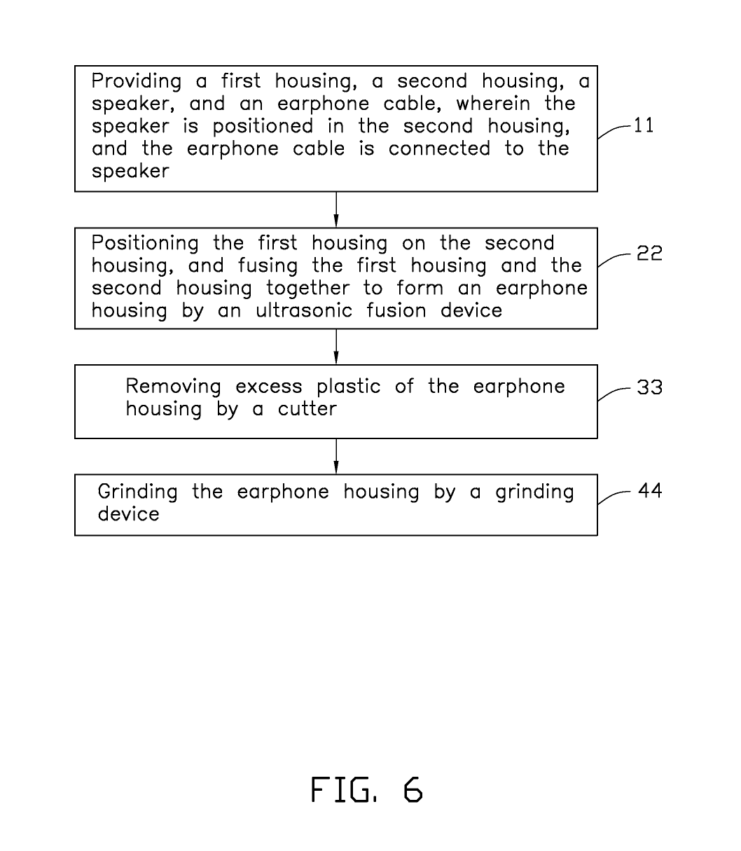

Referring to FIGS. 2 through 6, a method of manufacturing the earphone 100 of the first embodiment is described as follows. In a block 11 the first housing 21, the second housing 23, the speaker 90, and the earphone cable 30 can be provided. In the illustrated embodiment, the speaker 90 can be positioned in the second housing 23, and the earphone cable 30 can extend through the second housing 23 to electrically connect to the speaker 90.

In a block 22, the first housing 21 can be fused to the second housing 23 by the ultrasonic fusion device 40. In the illustrated embodiment, the second housing 23 can be positioned in the positioning frame 41, and the first housing 21 can be positioned on the second housing 23 to seal the speaker 90, with the first connecting surface 213 abutting the second connecting surface 233. The fusing head 43 can press on the first housing 21, and fuses the first housing 21 and the second housing 23 together to form the earphone housing 20. A fusing line 24 can be formed between the first housing 21 and the second housing 23 after fusing, and an amount of excess plastic can be formed to be arranged along the fusing line 24.

In a block 33, the excess plastic of the earphone housing 20 can be removed by the cutter 50. In the illustrated embodiment, the earphone housing 20 can be rotated, and the cutter 50 can be moved along the fusing line 24 to remove the excess plastic.

In a block 44, the earphone housing 20 can be ground by the grinding device 60. In the illustrated embodiment, the grinding surface 601 of the grinding device 60 can touch the side surface of the earphone housing 20. The earphone housing 20 can be rotated clockwise, and the grinding device 60 can be rotated counterclockwise along the fusing line 24.

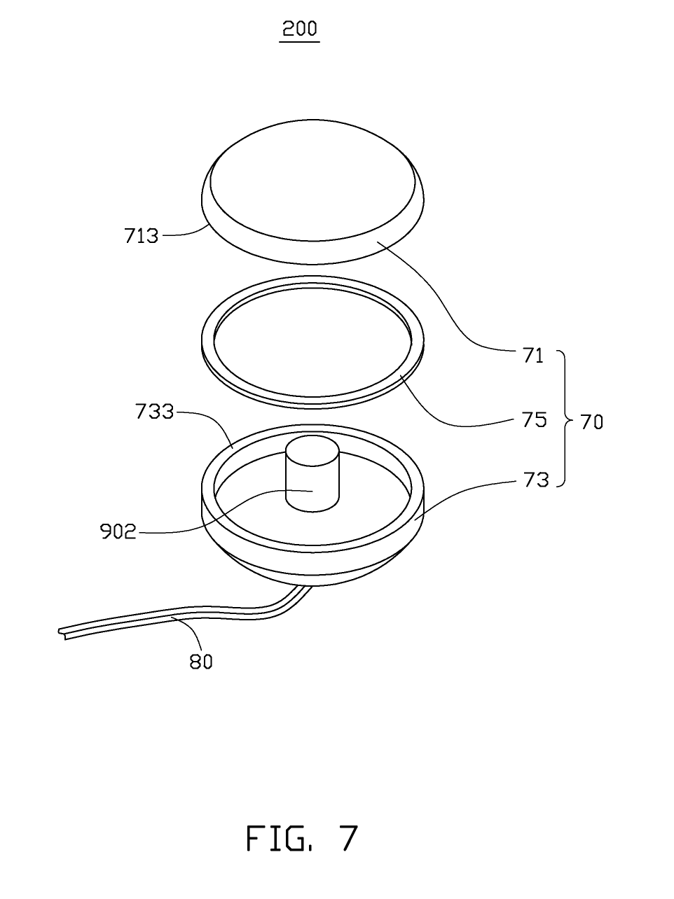

Referring to FIG. 7, a second embodiment of an earphone 200 can be similar to the earphone 100 of the first embodiment, except that a soft plastic piece 75 positioned on the second housing 73 before the first housing 71 is positioned on the second housing 73. Thus the soft plastic piece 75 can be positioned between the first connecting surface 713 of the first housing 71 and the second connecting surface 733 of the second housing 73. In the illustrated embodiment, the soft plastic piece 75 can be annular.

The positioning of the soft plastic piece 75 between the first housing 71 and the second housing 73, while the fusing head 43 can apply a pressing force on the first housing 21, alleviate and spread the pressing force between the first housing 71 and the second housing 73 during ultrasonic fusion. Therefore, the first housing 71 and the second housing 73 can be more accurately fused together. Furthermore, the earphone 200 having the soft plastic piece 75 can be less rigid, and thus users can obtain a comfortable feeling from the additional resiliency of the earphone housing 200.

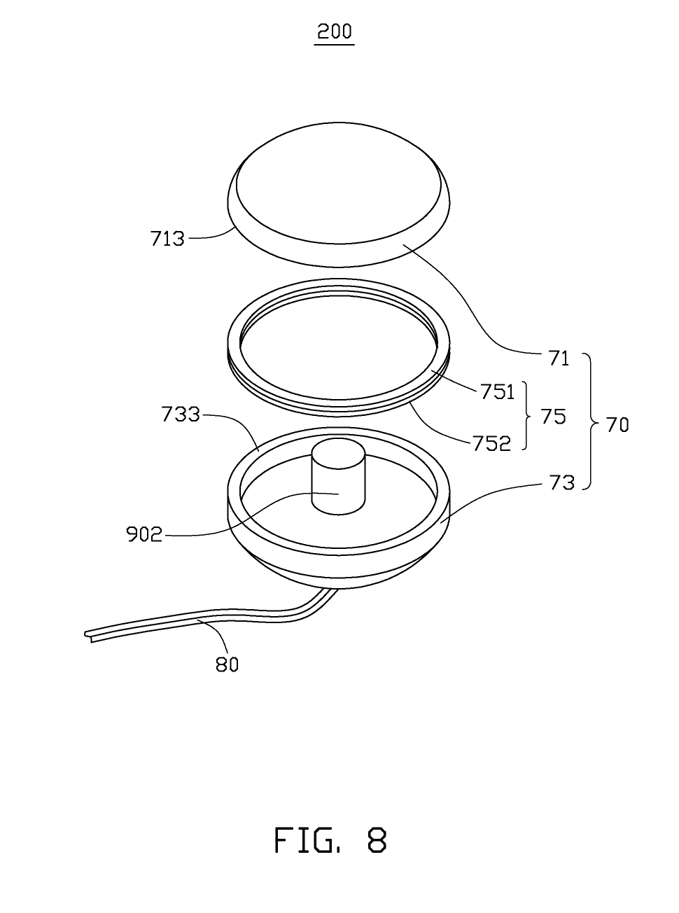

Referring to FIG. 8, in an alternative embodiment, the first housing 71 can be made of a first plastic material and the second housing 73 can be made of a second plastic material. The soft plastic piece 75 can include a first plastic layer 751 made of the first plastic material and a second plastic layer 752 made of the second plastic material can be formed by double-shot molding. In the fusion of the first housing 71 and the second housing 73, the first plastic layer 751 can be attached to the first housing 71, and the second plastic layer 752 can be attached to the second housing 73. The first plastic layer 751 and the first housing 71 being made of the same first plastic material, and the second plastic layer 752 and the second housing 73 being made of the same second plastic material, results in an improvement of the fusion-bonding quality between the first housing 71 and the second housing 73.

The embodiments shown and described above are only examples. Many details are often found in the art such as the other features of a electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including, the full extent established by the broad general meaning of the terms used in the claims. It will therefore be appreciated that the embodiments described above may be modified within the scope of the claims.

What is claimed is:

1. An earphone comprising:
an earphone housing comprising a first housing and a second housing, wherein the first housing forms a first connecting surface, the second housing forms a second connecting surface, the first connecting surface abutting the second connecting surface such that the first housing and the second housing are fused together;
a plastic piece positioned between the first connecting surface and the second connecting surface;
a speaker positioned in the earphone housing; and
an earphone cable connected to the speaker.

2. The earphone of claim 1, wherein the first housing and the second housing are made of one or more plastic materials.

3. The earphone of claim 1, wherein the earphone cable extends through the second housing, and is electrically connected to the speaker.

4. An earphone comprising:
an earphone housing comprising a first housing and a second housing;
a plastic piece;
a speaker positioned in the earphone housing; and
an earphone cable connected to the speaker;
wherein the plastic piece is positioned between the first housing and the second housing, and the plastic piece, the first housing and the second housing are fused together.

5. The earphone of claim 4, wherein the first housing and the second housing are made of one or more plastic materials.

6. The earphone of claim 5, wherein the first housing is made of a first plastic material, the second housing is made of a second plastic material; the plastic piece comprises a first plastic layer made of the first plastic material being attached to the first housing, and a second plastic layer made of the second plastic material being attached to the second housing.

7. The earphone of claim 4, wherein the earphone cable extends through the second housing, and is electrically connected to the speaker.

8. The earphone of claim 4, wherein the plastic piece is annular.

9. An earphone comprising:
an earphone housing comprising a first housing and a second housing, the first housing being made of a first plastic material, the second housing being made of a second plastic material;
a plastic piece comprising a first plastic layer and a second plastic layer, the first plastic layer being made of the first plastic material and attached to the first housing, the second plastic layer being made of the second plastic material and attached to the second housing;
a speaker positioned in the earphone housing; and
an earphone cable connected to the speaker.

10. The earphone of claim 9, wherein the earphone cable extends through the second housing, and is electrically connected to the speaker.

11. The earphone of claim 9, wherein the plastic piece is annular.
